(19) United States
(12) Patent Application Publication
(10) Pub. No.: US 2025/0300850 A1
(43) Pub. Date: Sep. 25, 2025

(54) AIR-GROUND INTEGRATED WIRELESS DATA TRANSMISSION METHOD FOR WIDE-AREA INTERNET OF THINGS

(71) Applicant: Harbin Institute of Technology, Harbin (CN)

(72) Inventors: Weixiao Meng, Harbin (CN); Zheng Guo, Harbin (CN); Chenguang He, Harbin (CN); Shuyi Chen, Harbin (CN); Yang Li, Harbin (CN); Yuchuan Ma, Harbin (CN); Hao Chen, Harbin (CN); Qiushi Zhang, Harbin (CN); Jiapeng Song, Harbin (CN); Haiying Zhang, Harbin (CN); Zhiqun Wang, Harbin (CN)

(21) Appl. No.: 18/883,397

(22) Filed: Sep. 12, 2024

Related U.S. Application Data
(63) Continuation of application No. PCT/CN2024/084756, filed on Mar. 29, 2024.

(30) Foreign Application Priority Data
Mar. 20, 2024 (CN) 202410316622.9

(51) Int. Cl. H04L 12/28; G16Y 10/75; G16Y 20/10; G16Y 40/30; H04L 67/12

(52) U.S. Cl. CPC H04L 12/2854; H04L 67/12; G16Y 10/75; G16Y 20/10; G16Y 40/30

(57) ABSTRACT

Provided is an air-ground integrated wireless data transmission method for wide-area Internet of Things. The method includes: S1: designing a data acquisition subsystem; S2: designing an information relay subsystem; S3: designing a network access subsystem; S4: designing a flight control system of an unmanned aerial vehicle; S5: designing a power supply system; and S6: designing a shell of a data relay system. The data acquisition subsystem can realize acquisition of sensor data such as temperature and humidity, wind speed and illumination and video data, with a wide coverage area and low power consumption. The information relay subsystem supports multi-hop communication, which can effectively reduce network transfer delay. The network access subsystem supports public network data transmission and private network data transmission. The flight control system of the unmanned aerial vehicle increases flexibility and stability of flight of the unmanned aerial vehicle, and designs a reasonable power supply system.

### CROSS-REFERENCE TO RELATED APPLICATIONS

This application is a continuation of PCT/CN2024/084756, filed on Mar. 29, 2024 and claims priority of Chinese Patent Application No. 202410316622.9, filed on Mar. 20, 2024, the entire contents of which are incorporated herein by reference.

### TECHNICAL FIELD

The present disclosure relates to the technical field of wireless communication, in particular to a big data transmission method applied to a wide-area Internet of Things scene.

### BACKGROUND

At present, the industry scale of the global Internet of Things is growing rapidly. It is estimated that by 2025, the scale of the global Internet of Things terminals exceeds 25 billion, and the scale of the Internet of Things market exceeds 50 trillion yuan. China has listed the Internet of Things as a strategic emerging industry with national key development. Benefiting from China's global leading 3C industrial chain and strong market demand, the Internet of Things companies on the ground network have completed commercialization in recent years. The arrival of the 5G era provides greater opportunities for the application of the Internet of Things. There are two objectives of 5G communication. One is to greatly improve the service rate of users, and the other more important one is to realize the Internet of Everything. Agricultural management, engineering construction, maritime transportation and energy industry become the most important application direction of the Internet of Things, and have a significant impact on the development pattern of related industries.

The acquisition of big data in wide-area Internet of Things plays an important role in the development of information society. In military and civil scenes, accurate and timely information transmission is the key factor to improve production efficiency and make decisions scientifically. For example, in the civil scene, the big data sensor network can promote the digital and intelligent development of rural agriculture. By deploying a certain number of sensors, all kinds of data of farmland, crops, agricultural meteorology, etc., such as soil humidity, temperature, illumination and meteorological conditions can be perceived and acquired in real time, which help farmers understand the growing environment of farmland and provide scientific basis for agricultural production decision-making. In the military communication system, information is the core of battlefield decision-making, troop dispatch and intelligence analysis. Using battlefield situation data, the command center can quickly understand the development of the war situation, adjust tactics and strategies, and convey key instructions. Therefore, an efficient and reliable wide-area wireless big data transmission method is very important for military and civil scenes. However, in the wide-area Internet of Things scene, information acquisition and transmission usually face the following problems:

The coverage area of the base station is small, and the signal quality is poor. At present, 5G base stations are mainly deployed in urban hots pots. The terrains in wide and remote areas such as deserts, oceans and forests are complex, the distribution of big data sensing devices is dispersive, and the coverage of ground communication network infrastructures is insufficient. Long-distance device information is usually difficult to transmit to the data center wirelessly, and the communication process often faces problems such as signal instability, connection interruption and slow data transmission, which affects the real-time monitoring and decision-making of the data cloud center.

The demand for data security and privacy protection has increased. The key device information usually contains important perception data, such as the key operational information in the military battle scene and the production state information of the metal and mineral industry. How to ensure that the transmitted information is not likely to be stolen in the communication network and the data security and privacy protection of massive big data devices have become important hot-spot issues.

Aiming at the above problems, the present disclosure focuses on the wireless big data transmission requirements in wide-area Internet of Things scenes and military scenes, and puts forward a new air-ground integrated wireless big data transmission method based on an unmanned aerial vehicle for wide-area Internet of Things, combining 5G and LoRa technologies.

### SUMMARY

An objective of the present disclosure is to provide an air-ground integrated wireless data transmission method for wide-area Internet of Things, which may realize low-cost and encrypted transmission of big data with unmanned aerial vehicle networking and low-power Internet of Things technology, and also has the characteristics of flexible deployment.

The technical solution used by the present disclosure is specifically as follows:

The air-ground integrated wireless data transmission method for wide-area Internet of Things includes:
S1: designing a data acquisition subsystem;
S2: designing an information relay subsystem;
S3: designing a network access subsystem;
S4: designing a flight control system of an unmanned aerial vehicle;
S5: designing a power supply system; and
S6: designing a shell of a data relay system.

The data acquisition subsystem includes a sensor information acquisition module, a LoRa data transmission terminal module and an H264 video coding module which are shown as follows:

the sensor information acquisition module uses an RS485 bus and an MODBUS-RTU protocol interface to support a temperature and humidity sensor, a wind speed sensor and an illumination sensor.

The LoRa data transmission terminal module is connected to the sensor information acquisition module by means of the RS485 bus.

The H264 video coding module is divided into an NAL layer and a VCL layer.

The NAL layer splits a frame into a plurality of packets for transmission, and each Ethernet packet is no more than 1500 bytes in a transmission process.

The VCL layer is responsible for compressing original video data, and dynamically setting a compression ratio according to service requirements and link characteristics to achieve adaptive transmission.

The information relay subsystem includes hardware components and internal software.

The hardware components include a LoRa communication module, a WiFi network card, a central controller and a 5G module.

Flow design of the internal software is as follows:
M1: polling sensor data with the central controller, and storing the sensor data;
M2: applying an Aodv multi-hop routing protocol;
M3: performing data analysis and processing by the central controller; and
M4: supporting public network data transmission and private network data transmission.

The network access subsystem is composed of a 5G base station, a 5G core network and a service server, and a Socket network for public network data transmission and a private communication network system for private network data transmission are arranged separately which are shown as follows:

the private communication network system is composed of a 5G Pico base station, a 5G core network and a service server.

The Socket network communication process includes:
Q1, server monitoring: making the server in a state of waiting for connection, and monitoring a network state in real time;
Q2, a client request: making a connection request by a client socket, firstly defining a socket of a target server by the client socket, defining an IP address and port number of the server socket, and then making a connection request to the server socket; and
Q3, connection confirmation: when the server socket receives the connection request of the client socket, responding to the request of the client socket, establishing a new thread, sending configuration information of the server socket to a client, and once the client confirms the information, establishing communication connection therefrom; and further, making the server socket still in a monitoring state, and continuing to receive connection requests from other clients.

The flight control system of the unmanned aerial vehicle includes:
a flight control circuit board, configured to control a fixed wing, a multiple rotor, an intelligent vehicle and a movable robot architecture; and
Raspberry Pi, acquiring information from the flight control circuit board, and sending the information to a ground station by in the form of UDP.

The power supply system uses a three-port 5521 mobile power supply to supply power to the LoRa communication module, the 5G module and a Jetson NX development board, and the WiFi network card is powered and driven by the central controller.

The shell of the data relay system has a 5-hole and 2-layer structure as follows:
four 5G patch antennas are placed in four holes on the shell separately, and a LoRa radio frequency antenna is placed in the other hole.

A ventilation opening is reserved in the shell.

An upper layer of the shell is configured to allow the sensor information acquisition module, the LoRa data transmission terminal module, the H264 video coding module, the LoRa communication module, the WiFi network card, the central controller and the 5G module to be placed.

A power supply with a power of 12V is placed at a lower layer of the shell.

The present disclosure has the following technical effects:

The air-ground integrated wireless data transmission method for wide-area Internet of Things of the present disclosure reduces a construction cost of realizing wireless data transmission in wide-area Internet of Things in an existing method. The present disclosure may greatly reduce requirements of mass data transmission on construction density of the base stations, such that the problems of land lease, power supply, etc. required by the base stations are avoided.

The air-ground integrated wireless data transmission method for wide-area Internet of Things of the present disclosure expands a coverage area of an existing network. A communication mode of unmanned aerial vehicle supplementary coverage is put forward, in an area where vehicles are unable to reach, information collection and network access operation are completed by means of unmanned aerial vehicle networking. Networking communication between the vehicles and the unmanned aerial vehicle is supported, and networking technology may greatly improve efficiency of data transmission.

The air-ground integrated wireless data transmission method for wide-area Internet of Things of the present disclosure is low in carbon and environment-friendly. The present disclosure combines the LoRa technology of low-power wide-area Internet of Things and the 5G access technology, and only needs a small amount of energy consumption to realize long-distance data acquisition, and a communication distance may reach 5-10 km.

The air-ground integrated wireless data transmission method for wide-area Internet of Things of the present disclosure has strong expandability and high network robustness. Because of flexible mobility of unmanned aerial vehicle and the vehicles, positions and number of nodes may be adjusted at any time according to the needs. A network coverage area may be expanded or adjusted as needed to adapt to different application scenes and demand changes.

The air-ground integrated wireless data transmission method for wide-area Internet of Things of the present disclosure has high data privacy. The present disclosure supports private network communication, and authentication and ciphering are realized by an SIM card, such that present disclosure has the advantages of data not being likely to be intercepted, security and privacy.

### BRIEF DESCRIPTION OF THE DRAWINGS

FIG. 1 is a flow chart of an air-ground integrated wireless data transmission method for wide-area Internet of Things of the present disclosure.

FIG. 2 is a schematic diagram of the air-ground integrated wireless data transmission method for wide-area Internet of Things of the present disclosure.

FIG. 3 is a technical roadmap of the air-ground integrated wireless data transmission method for wide-area Internet of Things of the present disclosure.

FIG. 4 is a workflow chart of the air-ground integrated wireless data transmission method for wide-area Internet of Things of the present disclosure.

FIG. 5 is a hardware implementation diagram of the air-ground integrated wireless data transmission method for wide-area Internet of Things of the present disclosure.

FIG. 6 is a control flow chart of flight of an unmanned aerial vehicle of the present disclosure.

FIG. 7 is a monitoring interface diagram of core network data of examples of the present disclosure.

### DETAILED DESCRIPTIONS OF THE EMBODIMENTS

In order to make the objective and advantages of the present disclosure clearer and more specific, the present disclosure will be described in detail below with reference to examples. It should be understood that the following characters are only used to describe one or more specific embodiments of the present disclosure, and do not intended to strictly limit the scope of protection specifically requested by the present disclosure.

### Example

With the increase in the number of vehicles and the development of vehicle networking technology, as well as the wide application of an unmanned aerial vehicle platform in military and civil scenes, vehicles and an unmanned aerial vehicle are used to construct an air-ground integrated network, which may achieve fine management of production, efficient usage of resources and accurate monitoring of ecosystems, and further, when military communication devices are destroyed, an emergency communication network is quickly established. An objective of the present disclosure is to provide an air-ground integrated wireless big data information transmission method for wide-area Internet of Things, which realizes low-cost and encrypted transmission of big data with unmanned aerial vehicle networking and low-power Internet of Things technology, and also has the characteristics of flexible deployment.

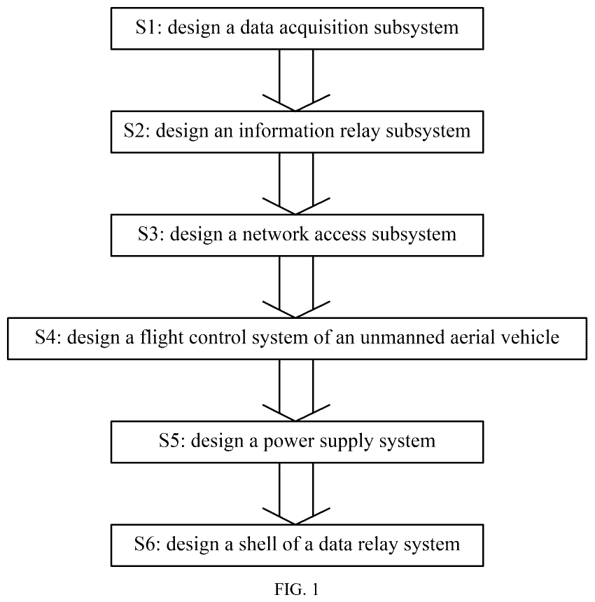

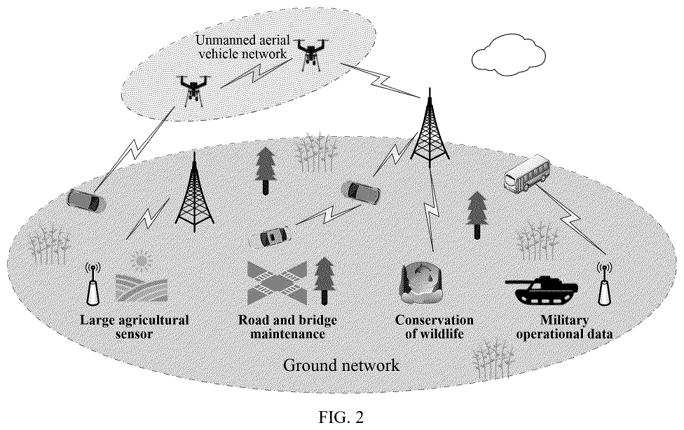

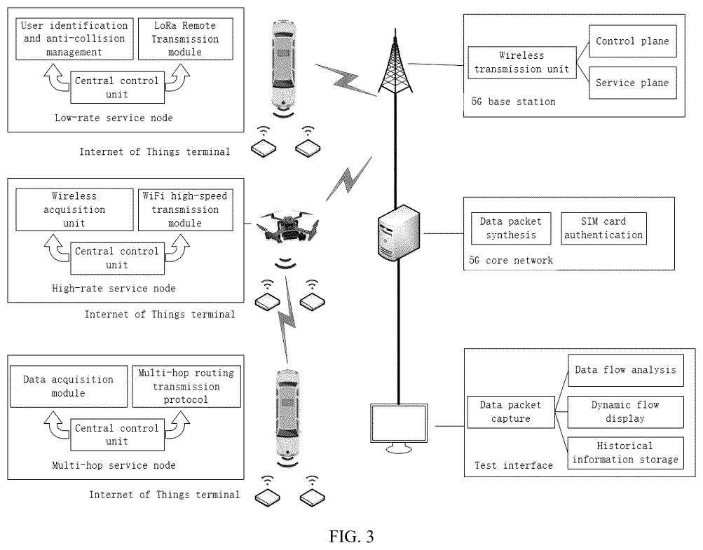

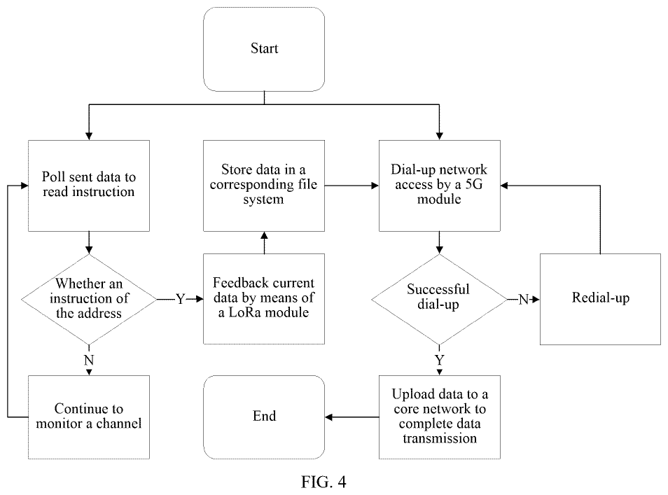

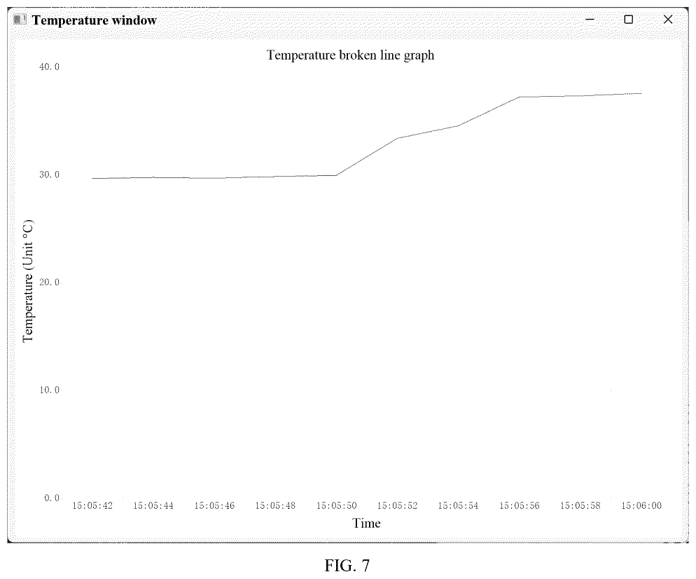

As shown in FIGS. 1-7, an air-ground integrated wireless data transmission method for wide-area Internet of Things includes:

Step 1: designing a data acquisition subsystem. The system supports data services and video streaming services, the data services, such as soil temperature and humidity, illumination and wind speed, are monitored with high-precision sensors. In order to reduce battery energy consumption, the sensors use passive information transmission, that is, data at the current moment are fed back after data acquisition instructions are received. The video streaming services are based on pictures photographed with a high-definition camera of Hikvision in real time, with H264 coding and a USB data interface. The data services and the video streaming services are transmitted by means of a long-distance LoRa transmission module with a WH-L102-L-P model and a WiFi wireless network card with an RT3070 model separately, and the data acquisition subsystem includes a sensor information acquisition module, a LoRa data transmission terminal module and an H264 video coding module, as shown below:

### (1) Sensor Information Acquisition Module

The sensor types supported by the system include temperature and humidity, wind speed, illumination, etc., which all use an RS485 bus and an MODBUS-RTU protocol interface, and a baud rate is set to 9600. The reading, address modification and baud rate modification of sensor data are based on hexadecimal instructions, which are shown in Table 1 below:

TABLE 1
Sensor configuration instructions of data acquisition subsystem

| Sensor type | Data operation | Instruction type | Remarks |
|---|---|---|---|
| Temperature and | Data reading | 01 03 00 00 00 02 C4 | Hexadecimal notation, 01 is an |
| humidity sensor | | 0B | device address, 03 is a function |
| | | | code, and C4 0B is a check code |
| | Data analysis | 01 03 04 00 79 00 7A | 00 79 is a data field, which is |
| | | DB EA | converted into hexadecimal to |
| | | | 121, and multiplying power is |
| | | | 100 |
| | Device address | FA 03 00 66 00 01 71 | FA is a general address, and 03 is |
| | query | 9E | a query function code |
| | Device address | 01 06 00 66 00 02 E8 | 01 is an initial address of a device, |
| | changing | 14 | 06 is the function of changing the |
| | | | address, and 02 is the changed |
| | | | address |
| | Baud rate reading | 01 03 00 67 00 01 35 | 01 is a device address, and 03 is a |
| | | D5 | reading function |
| | Baud rate changing | 01 06 00 67 00 05 F8 | 01 is the device address, 00 05 is a |
| | | 16 | target baud rate, and F8 16 is the |
| | | | check code |
| Wind speed/ | Data reading | 01 03 00 00 00 01 84 | Hexadecimal notation, 01 is the |
| illumination | | 0A | device address, 03 is the function |
| sensor | | | code, and 84 0A is the check code |
| | Data analysis | 01 03 04 10 4A 00 7A | 10 4A is the data field, which |
| | | 2E 3D | needs to be converted into |
| | | | hexadecimal, and the multiplying |
| | | | power is 100 |
| | Device address | FA 03 00 66 00 01 71 | FA is the general address, and 03 |
| | query | 9E | is the query function code |
| | Device address | 01 06 00 66 00 06 2A | 01 is the initial address of the |
| | changing | 14 | device, 06 is the function of |
| | | | changing the address, and 06 is |
| | | | the changed address |
| | Baud rate reading | 01 03 00 67 00 01 35 | 01 is a device address, and 03 is a |
| | | D5 | reading function |
| | Baud rate changing | 01 06 00 67 00 05 F8 | 01 is the device address, 00 05 is |
| | | 16 | the target baud rate, and F8 16 is |
| | | | the check code |

### (2) LoRa Data Transmission Terminal Module

The module has the characteristics of high transmit-receive sensitivity, a WH-L102-L-P wireless terminal purchased from the market may be selected, the wireless terminal is a low-frequency half-duplex LoRa module supporting the concentrator communication protocol, and a working frequency band thereof is 398-525 MHz. The communication mode is serial port communication, and a serial port is used to transmit and receive the data, which reduces a threshold of wireless application. The low-frequency half-duplex LoRa module has the advantages of concentrated power density and strong anti-interference ability. The module may be directly connected to an RS485 sensor with a baud rate of 9600 and a communication distance of 5000 meters, and the module and the sensor need to be used in pairs.

### (3) H264 Video Coding Module

The H264 video coding module is divided into two layers, as shown below:
A) an NAL layer, which ensures that each Ethernet packet is 1500 bytes in a transmission process, a frame encoded by an H264 video is usually larger than 1500 bytes, therefore it is necessary to perform packet disassembly on a frame into a plurality of packets for transmission, and packet disassembly and packet assembly are handled by means of the NAL layer.
B) a VCL layer, which is responsible for compressing original video data, and may dynamically set a compression ratio according to different service requirements and link characteristics to achieve adaptive transmission.

Step 2: designing an information relay subsystem. The information relay subsystem includes hardware components and internal software.

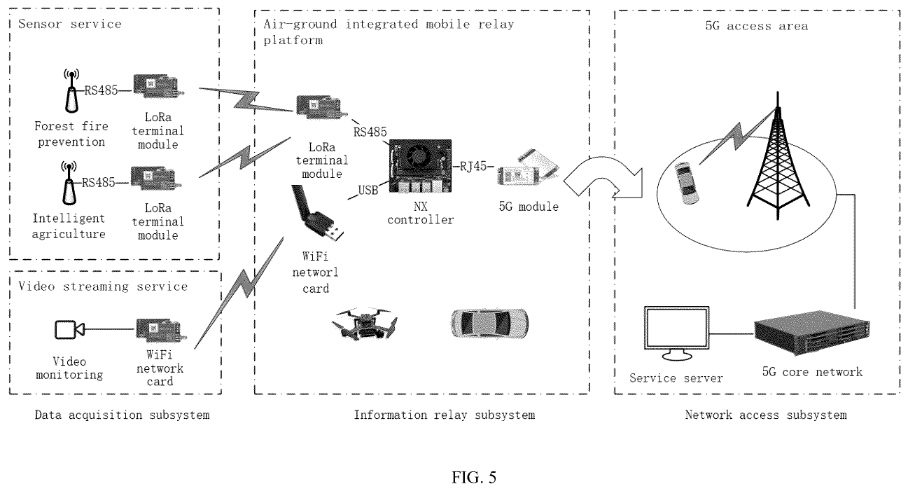

The subsystem completes the storage and forwarding of big data information in the Internet of Things, and for services with high delay requirements, transmission may be further completed by means of multi-hop links between air-ground platforms to reduce network delay. The hardware components includes a LoRa communication module with a WH-L102-L-P model, a WiFi network card with an RT3070 model, a central controller and a 5G module with an M328 model, among which Jetson NX development board purchased from the market may be selected as the central controller, and interfaces among the modules are shown in FIG. 5. Flow design of the internal software thereof is as follows:

M1: polling sensor data with the central controller, and storing the sensor data.

The central controller outputs data query instructions by means of a USB serial port, in order to avoid channel collision caused by simultaneous sending of data by the plurality of sensors, connection is established with only one specific sensor at a time by polling, and the data are acquired and stored in a solid-state disk of the central controller, and the sensor data are saved in separately created document files. After the central controller sends data frames to the LoRa communication module, the LoRa communication module sends the data frames to the LoRa data transmission terminal module of the data acquisition subsystem in the form of point-to-point communication, and all the nodes that successfully access the network receive the data frames according to an address order and transparently forward the data frames to the sensors, and the sensors that recognizes the data instructions reply the data, and upload the data to the central controller by means of the LoRa communication module.

M2: applying an Aodv multi-hop routing protocol.

The Aodv multi-hop routing protocol is used between the vehicles and the unmanned aerial vehicle to realize air-ground networking, which improves information transmission efficiency. According to IP addresses of a source node and a destination node, the protocol may automatically select the fastest path and forward the data to a corresponding relay platform, such that the service delay is reduced. An IP of a networking segment is set to 10.1.1.X, which is transmitted by means of the wireless network card with an RT3070 model. Each air-ground platform has an own IP address of a destination server and a networking IP address, when data are transmitted, the nodes close to a cloud server usually play the role of a network relay, which transmits not only the data acquired by the local platform to a target server, but also receives data of the adjacent nodes and forwards the data to destination IPs of the adjacent nodes.

M3: performing data analysis and processing by the central controller.

A core module of the Jetson NX development board is carries 384 CUDA cores, 48 TensorCores, a 6-core Carmel architecture and 2 deep learning accelerator (NVDLA) engines, which may a plurality of neural networks in parallel. These functions are combined with video coding and decoding, which makes the Jetson NX development board be a preferred platform for running the plurality of neural networks in parallel and processing high-resolution data from the plurality of sensors at the same time. With super strong data processing ability, a data relay platform may intelligently analyze the changes of services according to the acquired data, and feed back analysis results to users in time to assist decision-making.

M4: supporting public network data transmission and private network data transmission.

The system supports data transmission by means of a common carrier network (public network) or data transmission by means of a private network, which is determined by the type of an SIM card in a card slot of the 5G module. A working mode of the 5G module is a network card mode, and the used central controller may directly acquire a real IP address of 5G, such as 10.10.10.1, and may select to access the network by means of USB or Ethernet port according to AT command. When data statistics needs to be sent by means of a private network system, SIM card authentication information needs to be provided. Network access of the 5G module is realized by automatic dial, and SIM card information of private network data transmission is configured as follows:
SUPI: 46029760010*2538*.
Authentication key: 12345678123456781234567812345678.
Authentication OP: 4DC34FD479D23E5D173871C6C997B5E3.

Private network data transmission may have less data uploading pressure while ensuring privacy and security of the data, which is suitable for scenes with high user privacy requirements and military communication scenes. When a ground infrastructure is destroyed, a stable and secure private communication network is quickly established.

Step 3: designing a network access subsystem, as follows:

The network access subsystem is composed of a 5G base station, a 5G core network and a service server. For public network data transmission, it is necessary to establish communication connection by means of a Socket network with the help of a ground base station of a carrier. Private network data transmission has the characteristics of exclusive links and safe and reliable data. When the data are sent to a private communication network system, it is necessary to build a base station, a core network and switch links, and further, it is necessary to set a working mode, cell identification and a working frequency band of a private network base station.

### (1) Construction of the Private Communication Network System.

The private communication network system is composed of a 5G Pico base station, a 5G core network and a service server, shown as follows:

N2/N3 (10G) and N6 (10G) interfaces of the 5G core network and an optical interface (25G) of the 5G Pico base station are connected to a switch, which is configured to solve the problem of conversion compatibility of an optical module.

The service server is connected to the switch by means of an RJ45 interface in a wired manner to solve the problem of photoelectric conversion. After the data relay platform access a 5G network, massive data of Internet of Things are wirelessly transmitted to the base station by means of four radio frequency antennas, the base station sends the uplink data to the core network by means of the N2/N3 interface, and finally, the data are sent to the service server by means of the N6 interface of the core network.

### (2) Socket Network Communication Process.

Service data are uploaded to the cloud server by establishing Socket network connection to realize communication, which mainly includes three stages: server monitoring, client request and connection confirmation, as shown below:
Q1, server monitoring: making a server socket not locate a specific client socket, but in a state of waiting for connection, and monitoring a network state in real time;
Q2, a client request: making a connection request by the client socket, firstly defining a socket of a target server by the client socket, defining an IP address and port number of the server socket, and then making a connection request to the server socket; and
Q3, connection confirmation: when the server socket receives the connection request of the client socket, responding to the request of the client socket, establishing a new thread, sending configuration information of the server socket to a client, and once the client confirms the information, establishing communication connection therefrom; and further, making the server socket still in a monitoring state, and continuing to receive connection requests from other.

Step 4: designing a flight control system of an unmanned aerial vehicle, with steps as follows:

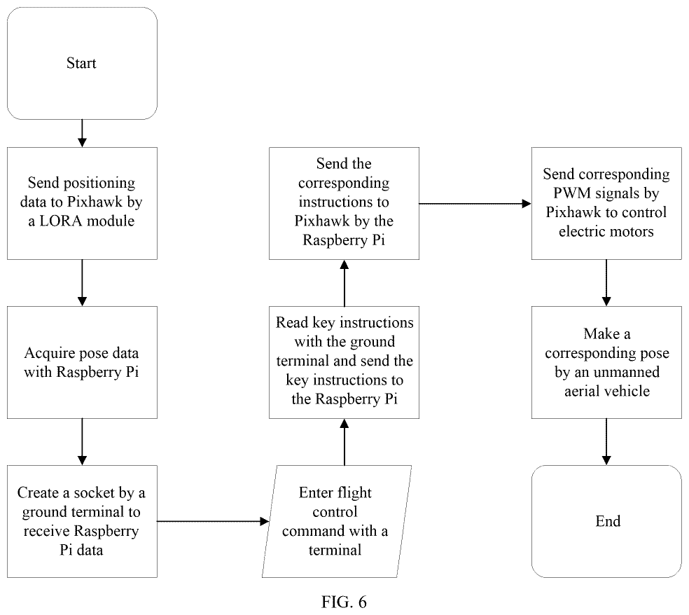

Pixhawk is selected as a flight control circuit board, Pixhawk is a circuit board configured to provide a control function and is suitable for controlling fixed wing, a multiple rotor, an intelligent vehicle and all movable robot architectures. The stable and good flight control of the unmanned aerial vehicle depends on a PID control algorithm. Pixhawk flight control circuit board receives current position information of the unmanned aerial vehicle, which is used as feedback to continuously correct parameters, so as to make the unmanned aerial vehicle approach a preset trajectory as much as possible. The flight control of the unmanned aerial vehicle is a complicated task, the flight control thereof may only be controlled after a position of the unmanned aerial vehicle is successfully determined and pose solution is performed, and a flight control flow is shown in FIG. 6.

After the unmanned aerial vehicle is started, the LoRa communication module sends current position data to the flight control circuit board according to an MAVLink communication protocol, and Raspberry Pi acquires information from the flight control circuit board and sends the information to a ground station in the form of UDP. A terminal inputs flight control instructions and sends the flight control instructions to the Raspberry Pi, the Raspberry Pi sends corresponding control signals to the Pixhawk flight control circuit board according to different instructions, and the flight control circuit board converts the signals into PWM signals to control four electric motors of a quadrotor to generate different rotating speeds, such that the flight control of the unmanned aerial vehicle is completed.

Expandability is strong, and network robustness is high. Because of flexible mobility of the unmanned aerial vehicle and the vehicles, the positions and number of nodes may be adjusted at any time according to the demand. A network coverage area may be expanded or adjusted as needed to adapt to different application scenes and demand.

Step 5: designing a power supply system, with steps as follows:

Because the unmanned aerial vehicle platform has the characteristics of limited load and limited battery energy, and a power interface required by ordinary vehicles and hardware involved in the system solution is inconsistent, it is necessary to optimize the power supply system of the modules of a data relay system. The actual working voltage of the LoRa communication module, the 5G module and the Jetson NX development board is 12 V, and the working current is 2 A. The WiFi network card is powered and driven by the central controller, the LoRa communication module, the 5G module and the Jetson NX development board are powered by a three-port 5521 mobile power supply, with a power weight of 0.5 Kg, and the mobile power supply is suitable for being carried by the unmanned aerial vehicle and the vehicles.

Step 6: designing a shell of the data relay system, with steps as follows:

Considering that the size and weight of the modules are quite different, and platform space resources that the unmanned aerial vehicle platform may carry are limited, therefore, the present disclosure considers scientific placement of module space positions and designs the shell with a 5-hole and 2-layer structure, as follows:

Four holes on the shell are configured to allow four 5G patch antennas to be placed separately, and one hole is configured to allow a LoRa radio frequency antenna to be placed.

A ventilation opening is reserved in the shell to avoid abnormal operation of the controller and the 5G module due to excessive temperature.

An upper layer of the shell is configured to allow the modules to be placed.

A power supply with a power of 12V is placed at a lower layer of the shell, the assembled size is 18 cm*16 cm*10 cm (length*width*height), and a total volume is 2.88 dm³.

In summary, the patent of the present disclosure provides the air-ground integrated big data transmission method based on an unmanned aerial vehicle for wide-area Internet of Things. Based on the unmanned aerial vehicle platform and the ground vehicles, the method realizes networking communication with multi-hop links, and realizes low-cost wide-area coverage of mass perception information by combining LoRa technology of low-power Internet of Things with wide-area coverage capability and new generation 5G access technology. The method includes the data acquisition subsystem, the information relay subsystem, the network access subsystem, the flight control system of the unmanned aerial vehicle, the power supply and shell design, which supports public network data transmission and private network data transmission, such that a construction cost of wireless data transmission for wide-area Internet of Things in the existing method is reduced. The present disclosure may greatly reduce requirements of mass data transmission on construction density of the base stations, such that the problems of land lease, power supply, etc. required by the base stations are avoided.

What is mentioned above is merely preferred embodiments of the present invention, it should be noted that those of ordinary skill in the art can also make several improvements and embellishments without departing from the principles of the present invention, and all the improvements and embellishments will also fall within the scope of protection of the present invention. The structures, apparatuses and operation methods not specifically described and explained in the present disclosure, unless specifically described and limited, are implemented by conventional means in the art.

1. An air-ground integrated wireless data transmission method for wide-area Internet of Things, comprising:
S1: designing a data acquisition subsystem;
S2: designing an information relay subsystem;
S3: designing a network access subsystem;
S4: designing a flight control system of an unmanned aerial vehicle;
S5: designing a power supply system; and
S6: designing a shell of a data relay system.

2. The air-ground integrated wireless data transmission method for wide-area Internet of Things according to claim 1, wherein the data acquisition subsystem comprises a sensor information acquisition module, a LoRa data transmission terminal module and an H264 video coding module;
the sensor information acquisition module uses an RS485 bus and an MODBUS-RTU protocol interface to support a temperature and humidity sensor, a wind speed sensor and an illumination sensor;
the LoRa data transmission terminal module is connected to the sensor information acquisition module by means of the RS485 bus; and
the H264 video coding module is divided into an NAL layer and a VCL layer.

3. The air-ground integrated wireless data transmission method for wide-area Internet of Things according to claim 2, wherein the NAL layer splits a frame into a plurality of packets for transmission, and each Ethernet packet is no more than 1500 bytes in a transmission process.

4. The air-ground integrated wireless data transmission method for wide-area Internet of Things according to claim 2, wherein the VCL layer is responsible for compressing original video data, and dynamically setting a compression ratio according to service requirements and link characteristics to achieve adaptive transmission.

5. The air-ground integrated wireless data transmission method for wide-area Internet of Things according to claim 1, wherein the information relay subsystem comprises hardware components and internal software; and
the hardware components comprise a LoRa communication module, a WiFi network card, a central controller and a 5G module.

6. The air-ground integrated wireless data transmission method for wide-area Internet of Things according to claim 5, wherein flow design of the internal software is as follows:
M1: polling sensor data with the central controller, and storing the sensor data;
M2: applying an Aodv multi-hop routing protocol;
M3: performing data analysis and processing by the central controller; and
M4: supporting public network data transmission and private network data transmission.

7. The air-ground integrated wireless data transmission method for wide-area Internet of Things according to claim 1, wherein the network access subsystem is composed of a 5G base station, a 5G core network and a service server, and a Socket network for public network data transmission and a private communication network system for private network data transmission are arranged separately;
the private communication network system is composed of a 5G Pico base station, a 5G core network and a service server;
the Socket network communication process comprises:
Q1, server monitoring: making the server in a state of waiting for connection, and monitoring a network state in real time;
Q2, a client request: making a connection request by a client socket, firstly defining a socket of a target server by the client socket, defining an IP address and port number of the server socket, and then making a connection request to the server socket; and
Q3, connection confirmation: when the server socket receives the connection request of the client socket, responding to the request of the client socket, establishing a new thread, sending configuration information of the server socket to a client, and once the client confirms the information, establishing communication connection therefrom; and further, making the server socket still in a monitoring state, and continuing to receive connection requests from other clients.

8. The air-ground integrated wireless data transmission method for wide-area Internet of Things according to claim 1, wherein the flight control system of the unmanned aerial vehicle comprises:
a flight control circuit board, configured to control a fixed wing, a multiple rotor, an intelligent vehicle and a movable robot architecture; and
Raspberry Pi, acquiring information from the flight control circuit board, and sending the information to a ground station by in the form of UDP.

9. The air-ground integrated wireless data transmission method for wide-area Internet of Things according to claim 1, wherein the power supply system uses a three-port 5521 mobile power supply to supply power to the LoRa communication module, the 5G module and a Jetson NX development board, and the WiFi network card is powered and driven by the central controller.

10. The air-ground integrated wireless data transmission method for wide-area Internet of Things according to claim 1, wherein the shell of the data relay system has a 5-hole and 2-layer structure as follows:
four 5G patch antennas are placed in four holes on the shell separately, and a LoRa radio frequency antenna is placed in the other hole;
a ventilation opening is reserved in the shell;
an upper layer of the shell is configured to allow the sensor information acquisition module, the LoRa data transmission terminal module, the H264 video coding module, the LoRa communication module, the WiFi network card, the central controller and the 5G module to be placed; and
a power supply with a power of 12V is placed at a lower layer of the shell.
